(19) United States
(12) Patent Application Publication
(10) Pub. No.: US 2017/0112249 A1
(43) Pub. Date: Apr. 27, 2017

(54) Protective Wrap For Laptop Computer Combined With Built-In Ambidextrous Mouse Pad Functions

(71) Applicant: Clayton A. Peterson, Baton Rouge, LA (US)

(72) Inventor: Clayton A. Peterson, Baton Rouge, LA (US)

(21) Appl. No.: 15/402,121

(22) Filed: Jan. 9, 2017

(51) Int. Cl. A45C 13/00; G06F 1/16

(52) U.S. Cl. CPC A45C 13/002; G06F 1/1628; A45C 2013/1015

(57) ABSTRACT

A protective wrap device for storage and transport of a laptop computer which includes in its design and utility the ambidextrous use of a built-in mouse pad function.

### BACKGROUND OF THE INVENTION

1. Field of the Invention

This invention relates to a protective wrap and carrying or storage apparatus for a laptop computer device that includes within its design and utility an ambidextrous mouse pad function.

2. Description of the Related Art

The development of laptop computer technology has increasingly resulted in varying sizes, shapes and weights of laptop devices, including thinner and lighter designs. The portable nature of these machines requires that the prudent owner provide some form of protection in the carrying or storage of these devices. There are many options to carry and store laptop devices for protection and transport, including but not limited to, briefcase and/or sleeve-styled products.

Although virtually all laptop computers are designed with built-in mouse pad capabilities, most individuals purchasing these machines desire the use of a separate, wireless stand-alone or USB-connected mouse device for ease and increased speed of used The use of such a device in most all cases requires the additional need for some form of mouse pad for proper and efficient function of the device.

In many instances of laptop computer ownership, the user currently utilizes some other form of briefcase, backpack or other bag-style product to carry personal, work or other belongings. The purchase of an additional computer carrying case for purposes of protecting the device often becomes burdensome, inefficient and inconvenient. As a result, many simply transport their laptop computer in whatever carrying apparatus they normally have in use at the time.

When transporting a laptop computer, it is also typically necessary to carry a number of ancillary accessories, including but not limited to, power cords, data cables, mouse device and mouse pad. Misplacing or forgetting any one of these items can be extremely frustrating when the need to utilize the device arises.

### SUMMARY OF THE INVENTION

Accordingly, it is an aspect of the present invention to provide a convenient, protective wrap device for a laptop computer, which includes in its design and utility the ambidextrous use of a built-in mouse pad function. This dual purpose apparatus provides a convenient and more efficient manner in which to protect, transport and minimize the number of accessories necessary for the ideal and efficient use and function of a laptop computer.

The foregoing and/or other aspects of the present invention can be achieved by providing a laptop computer protective wrap and carrying or storage apparatus which consists of a single, cut and formed piece of base material of the type normally used for production of mouse pads, including but not limited to, neoprene or other acceptable substitute. The formed, base material may or may not include a printed or colored fabric or other form laminate on one or both sides of the wrap and may be produced in varying thicknesses. The formed, base material, folded or unfolded, serves as a padded underside support for the placement of a laptop computer device. Continuous, uninterrupted base material left and right side flaps are dimensioned and included in the base material form to provide padded coverage around the sides and top of the laptop computer and are secured with Velcro or other appropriate material or device. A larger, continuous and uninterrupted, primary flap provides protective cover for the top and front of the laptop and is similarly secured with Velcro or other appropriate material or device. The surface of the side flaps dually serve to provide sufficient area for the use of a wireless or connected mouse device when the wrap is unfolded. The mouse device can be used alternately on either the left or right side flaps of the wrap assuming a properly placed laptop.

### BRIEF DESCRIPTION OF THE DRAWINGS

In the detailed description that follows, reference will be made to the drawings comprised of the following figures:

FIG. 1 is a developed plan view illustrating the laptop computer protective wrap with mouse pads according to an embodiment of the present invention;

FIG. 2 is a view of the laptop computer protective wrap with mouse pads according to an embodiment of the present invention wherein the wrap is fully unfolded and exposing the interior side of the wrap;

FIG. 3 is a view of the laptop computer protective wrap with mouse pads according to an embodiment of the present invention wherein the wrap is fully unfolded and exposing the exterior side of the wrap;

FIG. 4 is a view of the laptop computer protective wrap according to an embodiment of the present invention wherein the wrap is shown at a side view indicating one mouse pad flap;

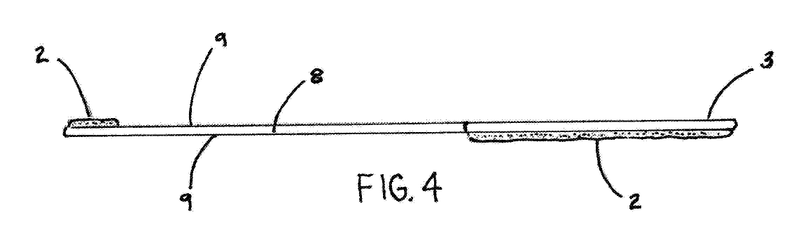

FIG. 5 is a view of the laptop computer protective wrap according to an embodiment of the present invention wherein the wrap is shown at an opposite side view from that shown in FIG. 4 above indicating the opposite side mouse pad flap;

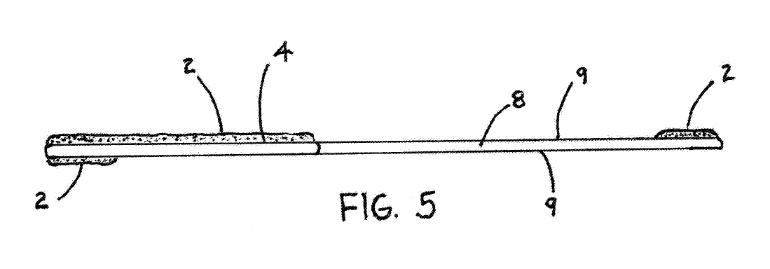

FIG. 6 is a view of the laptop computer protective wrap according to an embodiment of the present invention wherein the primary top flap is in an open position;

FIG. 7 is a view of the laptop computer protective wrap according to an embodiment of the present invention wherein the wrap is fully secured around the laptop computer;

FIG. 8 is a developed view illustrating the wrap fully unfolded from the perspective of the user with laptop computer in proper position and alternate mouse devices positioned for use.

FIG. 9 is a is a view of the laptop computer protective wrap according to an embodiment of the present invention and opposite that of FIG. 8 above wherein the wrap is fully secured around the laptop computer and further details a pocket attachment;

### DETAILED DESCRIPTION OF THE ILLUSTRATIVE NON-LIMITING EMBODIMENTS OF THE INVENTION

Reference will now be made in detail as to the embodiment of the present invention, examples of which are illustrated in the accompanying drawings and referenced in the Figures.

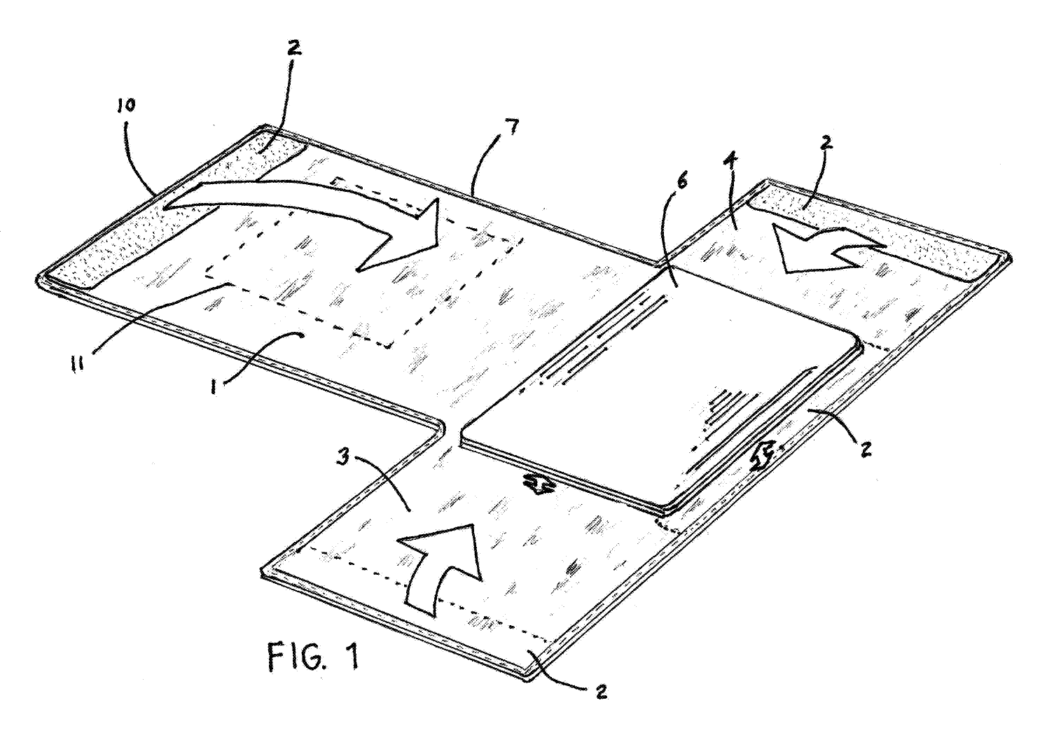

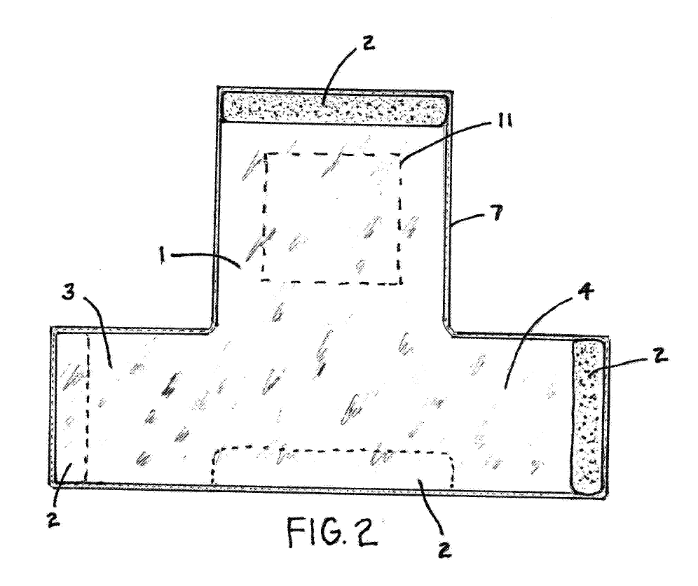

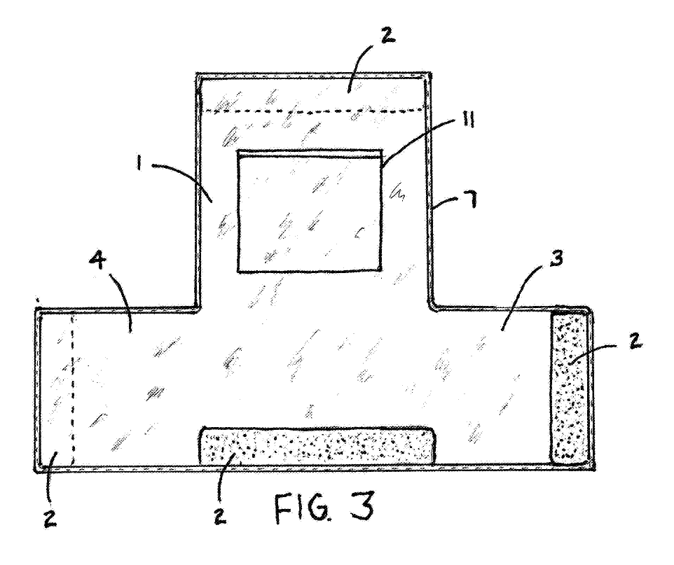

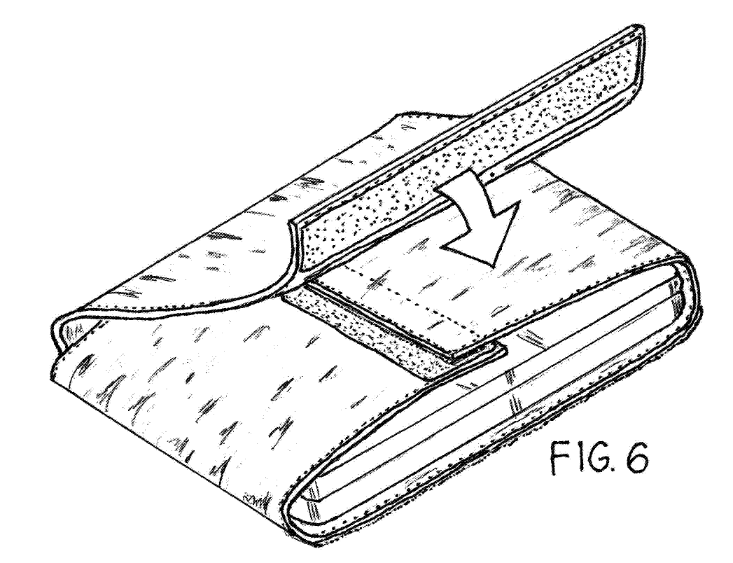

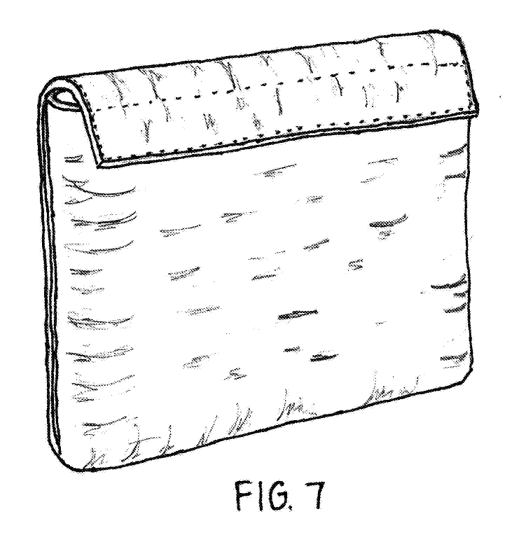

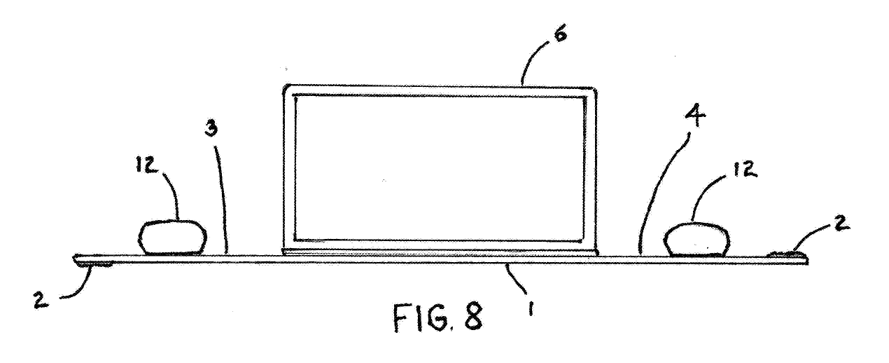

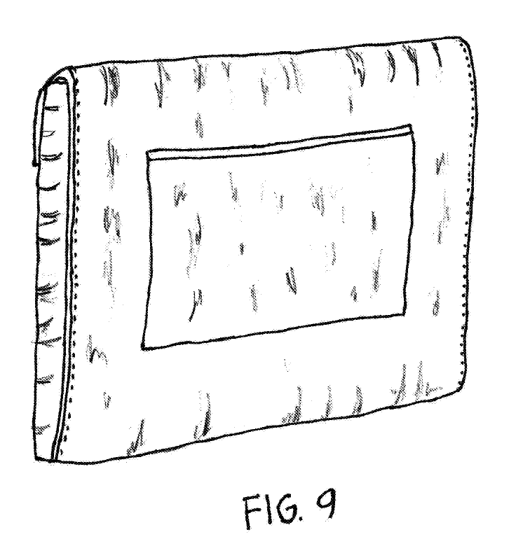

The laptop computer protective wrap with ambidextrous built-in mouse pad functions is comprised of a single, custom-cut base piece of neoprene 1 or other similar material typical to the manufacturing of mouse pads in a thickness measured approximately to that of typical mouse pad construction 8. The base material may or may not include a printed or colored fabric or some other form laminate on one or both sides of the piece 9. The base material may include a continuous sewn trim 7 or other woven or exposed edge. The base material as illustrated in its current configuration in the figures is intended to be custom-cut to accommodate varying sizes of laptop computers or dimensioned to accommodate a “one size fits all” design. FIG. 1 illustrates the wrap in a fully unfolded planar view with placement of a laptop computer 6 positioned centrally between flaps 3 and 4. With the wrap fully unfolded, flaps 3 and 4 are dimensioned to be of sufficient size for use of a mouse device by either a left or right-handed individual. A user perspective is illustrated in FIG. 8 indicating the a properly placed laptop computer 6 on the base material wrap 1 and the location of flaps 3 and 4 with mouse devices 12 deployed on both the left and right sides of the wrap. FIG. 2 illustrates a fully unfolded perspective of the inside of the wrap indicating the base material piece 1, left flap 3 and the right flap 4, Velcro or similar material or device fasteners 2, sewn, woven or alternately exposed trimming 7 and the underside view of a sewn or adhered pocket 11 located on the exterior portion of the wrap. FIG. 3 illustrates a fully unfolded perspective of the outside of the wrap indicating the base material piece 1, flap 3 and flap 4, Velcro or similar material or device fasteners 2, sewn, woven or alternately exposed trimming 7 and view of a sewn or adhered pocket 11. For the purpose of describing how to engage the wrap as a protective and/or transport apparatus, as further illustrated in FIG. 1, flaps 3 and 4 are folded over the top of the closed laptop computer and secured by Velcro 2, or other similar material or device. The remaining, larger primary flap 10 folds over the top and front edge of the laptop computer and is similarly secured by Velcro 2, or other similar material or device. FIGS. 6, 7 and 9 illustrate the protective wrap fully securing the laptop computer for transport or storage.

What is claimed is:

1. A laptop computer protective wrap with ambidextrous built-in mouse pad functions comprised of a single, custom-cut base piece of neoprene or other similar material typical to the manufacturing of mouse pads in a thickness measured to approximately that of typical mouse pad construction. The base material wrap may or may not include a printed or colored fabric or some other form laminate on one or both sides of the piece. The base material wrap may include a continuous sewn, woven or exposed trimmed edge. The base material wrap is intended to be custom-cut to accommodate varying sizes of laptop computers or dimensioned to accommodate a “one size fits all” design. The base material wrap is designed with a single large, primary flap for the purpose of covering the top and front of the laptop computer when fully folded and is secured by Velcro or similar material or device. This primary flap may or may not include a pocket for the purposes of storing or transporting laptop computer ancillary accessories or other items, said pocket attached in a sewn or adhesive manner and may or may not include a zipper function. The base material wrap includes smaller left and right flaps that are dually purposed for (i) covering the sides and top of the laptop computer when fully folded and are secured by Velcro or similar material or device, and (ii) use as a mouse pad function for left or right-handed users when the protective wrap is in a fully unfolded position with laptop computer properly placed on the wrap.

2. An alternative embodiment of the single, custom-cut base piece of neoprene or similar material detailed in claim 1, wherein the single, custom-cut base piece of neoprene or similar material could be substituted for printed or colored sewn fabric, vinyl or other suitable flexible material inserted with a suitable padded interior lining to provide for a similar level of protection when the wrap is fully engaged and folded around a laptop computer device. A properly dimensioned, separate neoprene or similar mouse pad material piece would attach in either an adhesive or sewn fashion directly onto the left and right flaps in the areas specifically intended for mouse device use. The general arrangement and configuration of the wrap is otherwise substantially the same as the embodiment of that outlined in claim 1.

3. The laptop computer protective wrap with ambidextrous built-in mouse pad functions as set forth in claim 1, wherein the material used as laminate that comprises one or more sides of the wrap may be printed or colored materials of varying styles, designs and textures.
